(19) United States
(12) Patent Application Publication
(10) Pub. No.: US 2025/0161993 A1
(43) Pub. Date: May 22, 2025

(54) SPRAYING INTERFACE FOR CLEANING PANELS

(71) Applicant: Rotem BEN-TAL, Kibbutz Mashabei-Sade (IL)

(72) Inventor: Rotem BEN-TAL, Kibbutz Mashabei-Sade (IL)

(21) Appl. No.: 18/723,431

(22) PCT Filed: Apr. 1, 2023
(86) PCT No.: PCT/IL2023/050012

§ 371 Date: Jun. 23, 2024

(30) Foreign Application Priority Data
Jan. 12, 2022 (US) 63/298654

(51) Int. Cl. B08B 3/02; B08B 13/00; H02S 40/10

(52) U.S. Cl. CPC B08B 3/02; B08B 13/00; H02S 40/10

(57) ABSTRACT

The present invention relates to a spraying interface for cleaning solar panels without damaging the solar panel and with a reduced shadowing profile. For example, a clamp may hold a sprinkler head and/or a water inlet to the panel. Optionally, the inlet is connected to a water supply conduit (e.g., a flexible tube).

### RELATED APPLICATION/S

This application claims the benefit of priority under 35 USC § 119(e) of U.S. Provisional Patent Application No. 63/298,654 filed 12 Jan. 2022, the contents of which are incorporated herein by reference in their entirety.

### FIELD OF THE INVENTION

The present invention, in some embodiments thereof, relates to a spraying interface for cleaning solar panels.

### BACKGROUND

A major portion of green electric power production in many countries over the world is provided nowadays by solar panels. The efficiency of conversion of sun light to solar energy by solar panels is typically about 20%. This is further reduced by accumulation on the solar panels of dust, pollen, grime, and other particulates, which is referred to as soiling. The efficiency loss due to soiling may be as high as 30%. There are estimates that the average soiling loss is at least 3-4% worldwide.

Thus, some have recommended cleaning solar panels several times a year. This may help maintain efficiency. However, manual cleaning may be more expensive than the soiling loss. Automatic cleaning systems based on sprayed water by sprinklers have been suggested and tried successfully. Currently, many automatic spraying systems require a system of water conduits disposed below the solar panels which feed water sprinklers positioned above the panels, which may shadow part of the solar panel.

Some systems couple the sprinkler to a conduit and fix it above the top surface of the solar panel by fixing a spraying interface to the edge of a solar panel, for example with a screw or bold passing through the wall of the panel body. Such a fixation may be disadvantageous, for example when completeness of the solar panel body is a condition of the long duration manufacturer warranty. It is preferable to reduce shadowing by the spraying interface of the solar panel. Such shadowing may cause a power reduction in of the shadowed area and/or areas linked to it.

### SUMMARY

According to an aspect of some embodiments of the invention, there is provided a device for cleaning solar panels including: a sprinkler head; an inlet attachable to a water conduit; a fluid path leading from the water inlet to the sprinkler head a clamp configured to clamp to a solar panel and support the sprinkler head, the inlet and the fluid path.

According to some embodiments of the invention, the clamp includes a clamp body including: a sprinkler connector on an upper portion of the clamp body; an upper support on an upper portion of the clamp body; at least one slot; and a conduit inlet on a base of the clamp body configured to be fluidically connected to the sprinkler connector by a fluid path; a plugging insert including a lower support and at least one fastening hook configured to be inserted through the at least one slot in the clamp body and reversibly locked in place by a securing element.

According to some embodiments of the invention, the fluid path is fully integrated within the clamp body.

According to some embodiments of the invention, the clamp body is a one-piece injected polymer product.

According to some embodiments of the invention, the device further includes a conduit clip configured to be attached to a water conduit and to be fixed in place by a securing ring.

According to some embodiments of the invention, the sprinkler head includes a sloped inner plane configured to spread water over an angle occupying a horizontal arc between about 90-300°, 120-250°, 180-230°, or 200-220°.

According to some embodiments of the invention, the sprinkler head includes a square base.

According to some embodiments of the invention, the sprinkler connector includes one or more sidewalls with one or more rails.

According to some embodiments of the invention, the plugging insert is partially or completely hollow.

According to some embodiments of the invention, the plugging insert is configured conform to various shapes and/or sizes of solar panels.

According to some embodiments of the invention, the plugging insert includes a lower support on an upper proximal edge.

According to some embodiments of the invention, the plugging insert includes at least one fastening hook on its distal end.

According to some embodiments of the invention, the conduit inlet includes a narrow neck and a shoulder.

According to some embodiments of the invention, the conduit inlet is configured to penetrate a water conduit.

According to some embodiments of the invention, a securing ring is configured to connect the conduit inlet to a conduit clip.

According to some embodiments of the invention, the device is configured to be connected to a solar panel without drilling, welding, screwing, gluing or damaging the solar panel.

According to an aspect of some embodiments of the invention, there is provided a method for installing a spray interface for cleaning solar panels, the method including: attaching a clamp to an upper edge of a solar panel; connecting an inlet to a water supply conduit.

According to an aspect of some embodiments of the invention, there is provided a method for installing a spray interface for cleaning solar panels, the method including: positioning a water conduit below a solar panel; attaching an upper support of a clamp body of the spray interface to an upper edge of a solar panel; inserting at least one fastening hook of a plugging insert through at least one slot in the clamp body, thereby fixing the lower support to the solar panel; securing the at least one fastening hook with a securing element; piercing the water conduit proximate to a conduit inlet on a base of the clamp body; penetrating the water conduit with a water inlet; securing the water inlet to the water conduit using a conduit clip secured by a securing ring; connecting a sprinkler head to a sprinkler connector on an upper portion of the clamp body; and aligning the sprinkler head to provide improved spray cleaning of a soiled solar panel.

According to some embodiments of the invention, the method further includes placing a conduit clip collar over a neck of the conduit inlet to rest over a shoulder of the conduit inlet, and lowering the securing ring over the collar to secure the conduit clip in place.

According to some embodiments of the invention, the method further includes linking the spraying interface to a system which is manually and/or automatically controlled.

According to some embodiments of the invention, the method further includes at least one weather sensor configured to prevent operation of the spraying interface during unfavorable weather conditions.

According to some embodiments of the invention, the method further includes at least one sensor to detect when cleaning of a solar panel is required to prevent loss of efficiency of the solar panel due to soiling.

According to some embodiments of the invention, the installing is without drilling, welding, screwing, gluing or damaging the solar panel.

According to some embodiments of the invention, the installing results in low to no shadowing of the solar panel.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the figures:

FIG. 1 is an exemplary image of a spraying interface fixed to an edge of a solar panel and connecting a water pipe with a water sprinkler in accordance with some embodiments of the invention;

FIG. 2 is an exemplary image of the spraying interface of FIG. 1, showing an upper support of the spraying interface holding the upper part of the solar panel edge in accordance with some embodiments;

FIG. 3 is a perspective view of a spraying interface in accordance with some embodiments of the invention;

FIG. 4 is an exploded view of a schematic illustration of a spraying interface in accordance with some embodiments of the invention;

FIG. 5 is a perspective view of a spraying interface in accordance with some embodiments of the invention;

FIG. 6 is a back view of a schematic illustration of a spraying interface in accordance with some embodiments of the invention;

FIG. 7 is a side view of a schematic illustration of a spraying interface in accordance with some embodiments of the invention;

FIG. 8 shows a perspective view of a schematic illustration of a spraying interface in accordance with some embodiments of the invention;

FIG. 9A-C are perspective views of schematic illustrations of various plugging inserts in accordance with some embodiments of the invention.

FIG. 10 is a block diagram of the main body of a spraying interface in accordance with some embodiments of the invention;

FIG. 11 is a block diagram of the spraying interface in accordance with some embodiments of the invention;

FIG. 12 is a flow diagram of the spraying interface in accordance with some embodiments of the invention;

FIG. 13 is a flow diagram of the spraying interface in accordance with some embodiments of the invention; and

FIG. 14 is a block diagram of the spraying interface in accordance with some embodiments of the invention.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the figures:

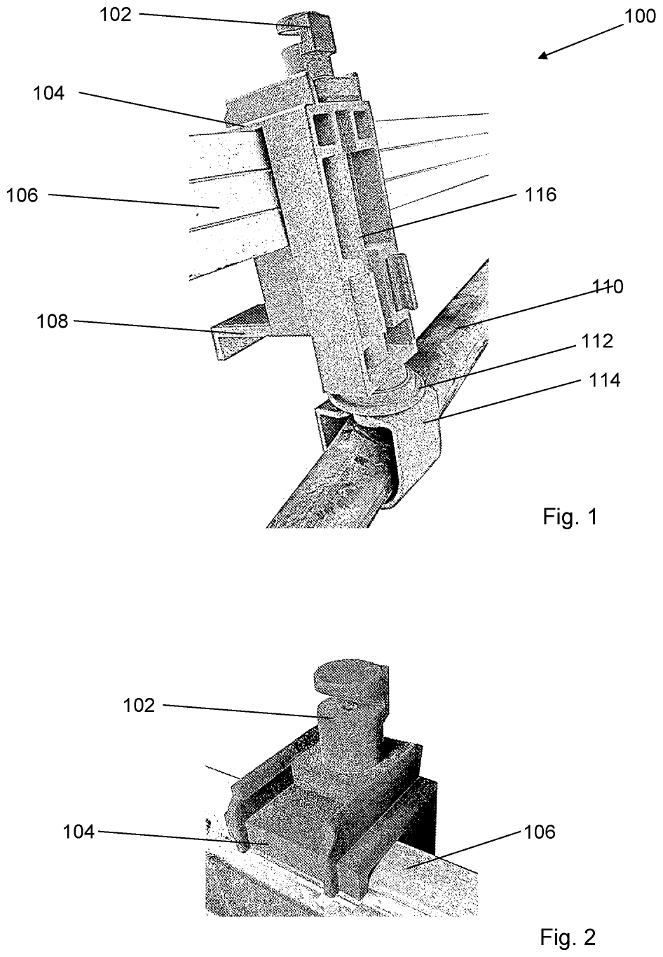

FIG. 1 is an exemplary image of a spraying interface fixed to an edge of a solar panel and connecting a water conduit with a water sprinkler in accordance with some embodiments of the invention;

FIG. 2 is an exemplary image of the spraying interface of FIG. 1, showing an upper support of the spraying interface holding the upper part of the solar panel edge in accordance with some embodiments;

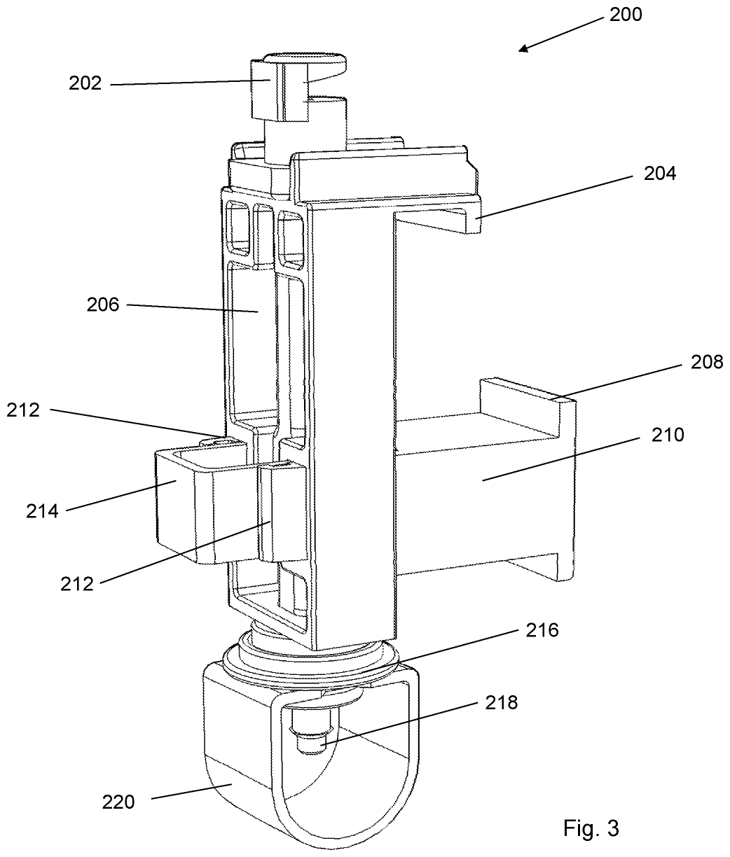

FIG. 3 is a perspective view of a spraying interface in accordance with some embodiments of the invention;

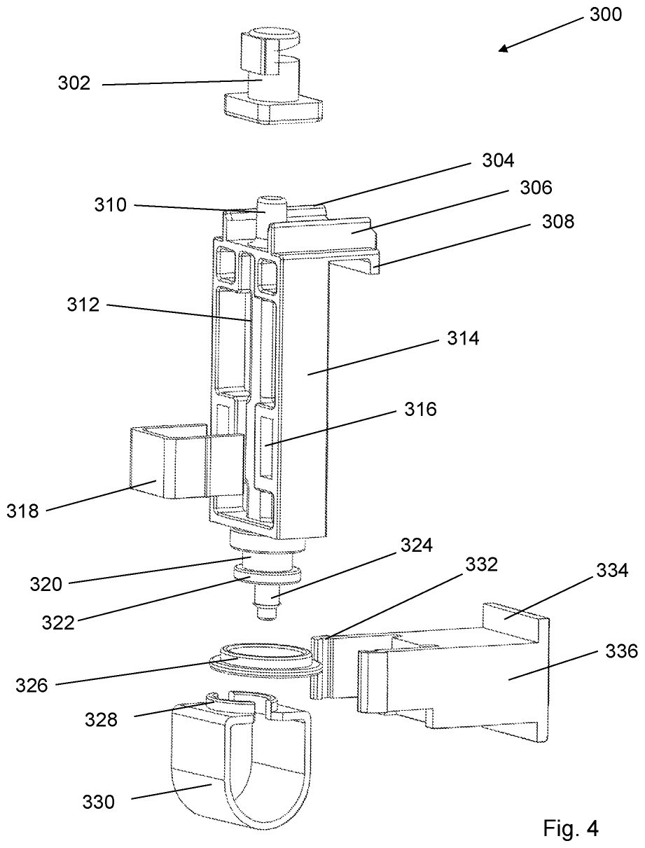

FIG. 4 is an exploded view of a schematic illustration of a spraying interface in accordance with some embodiments of the invention;

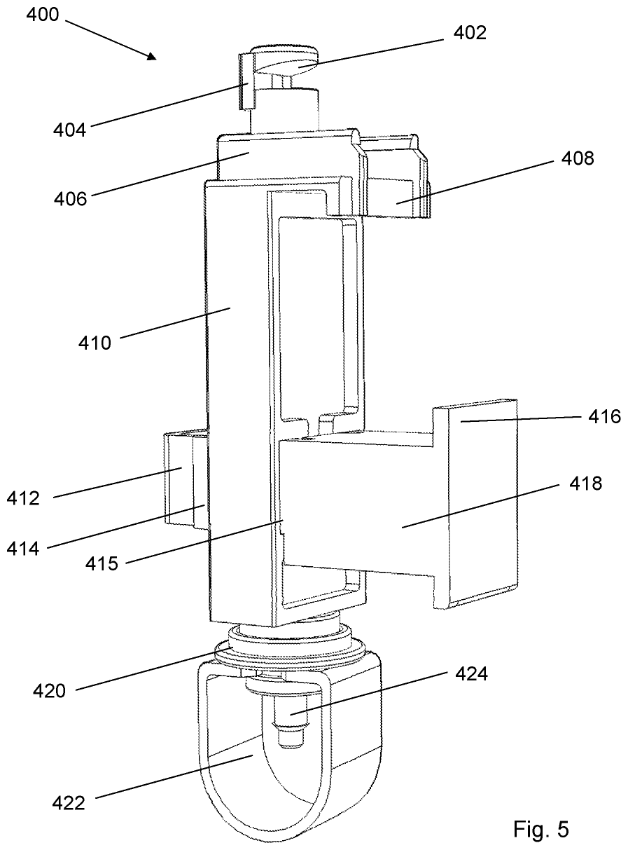

FIG. 5 is a perspective view of a spraying interface in accordance with some embodiments of the invention;

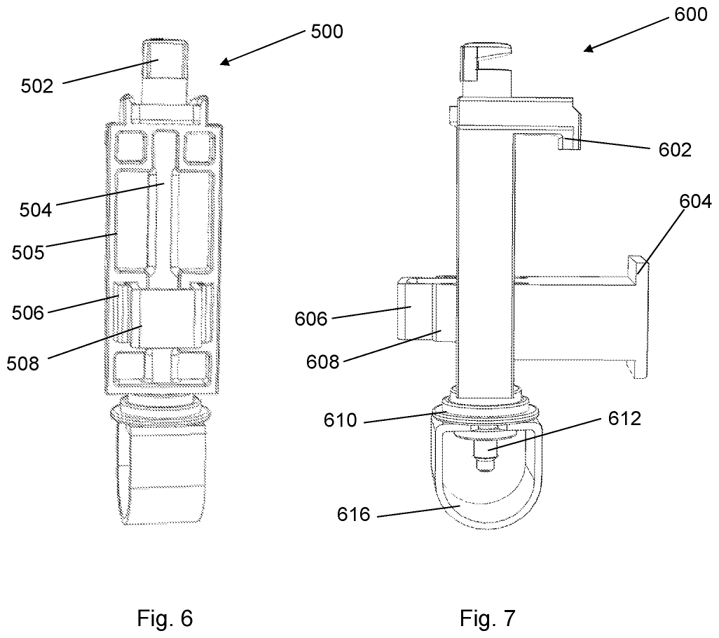

FIG. 6 is a back view of a schematic illustration of a spraying interface in accordance with some embodiments of the invention;

FIG. 7 is a side view of a schematic illustration of a spraying interface in accordance with some embodiments of the invention;

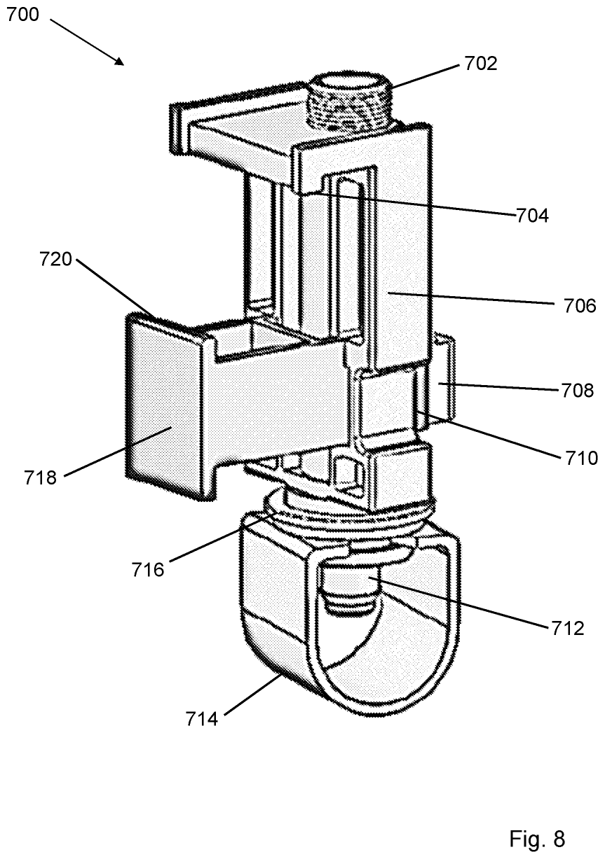

FIG. 8 shows a perspective view of a schematic illustration of a spraying interface in accordance with some embodiments of the invention;

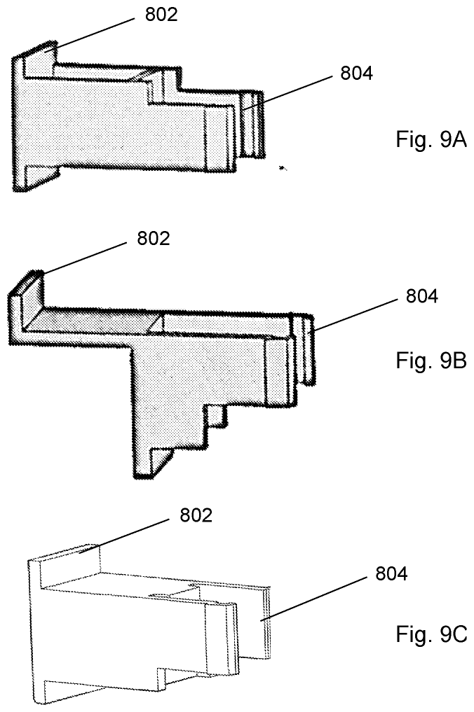

FIG. 9A-C are perspective views of schematic illustrations of various plugging inserts in accordance with some embodiments of the invention.

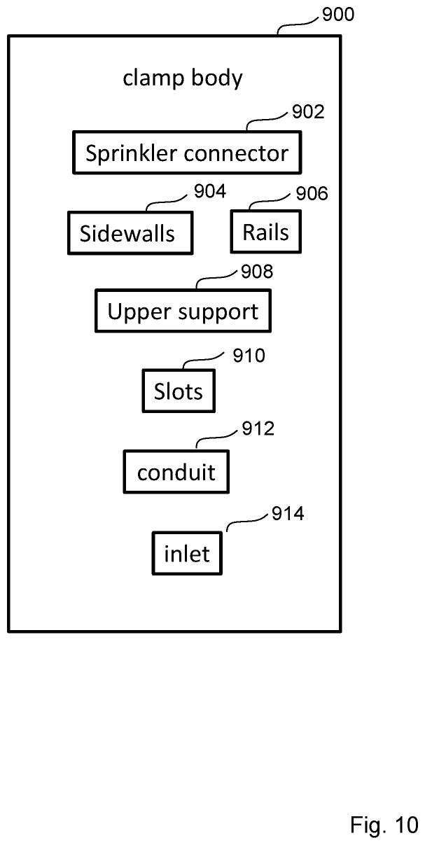

FIG. 10 is a block diagram of the clamp body of a spraying interface in accordance with some embodiments of the invention;

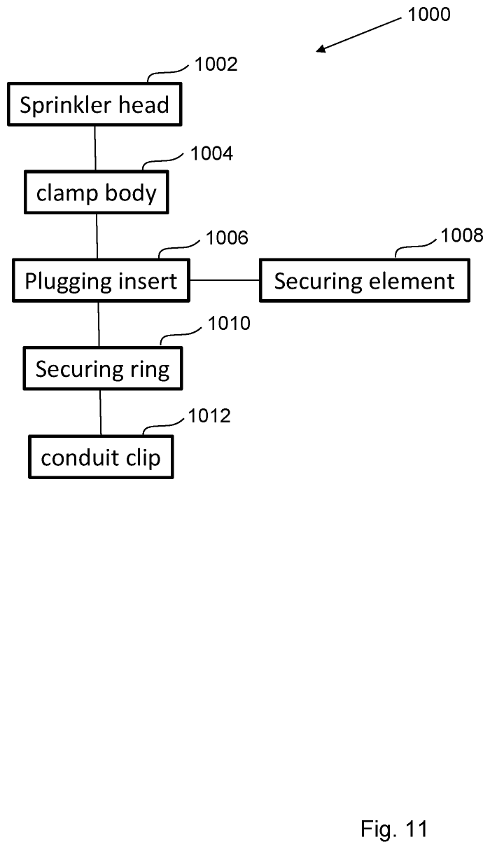

FIG. 11 is a block diagram of the spraying interface in accordance with some embodiments of the invention;

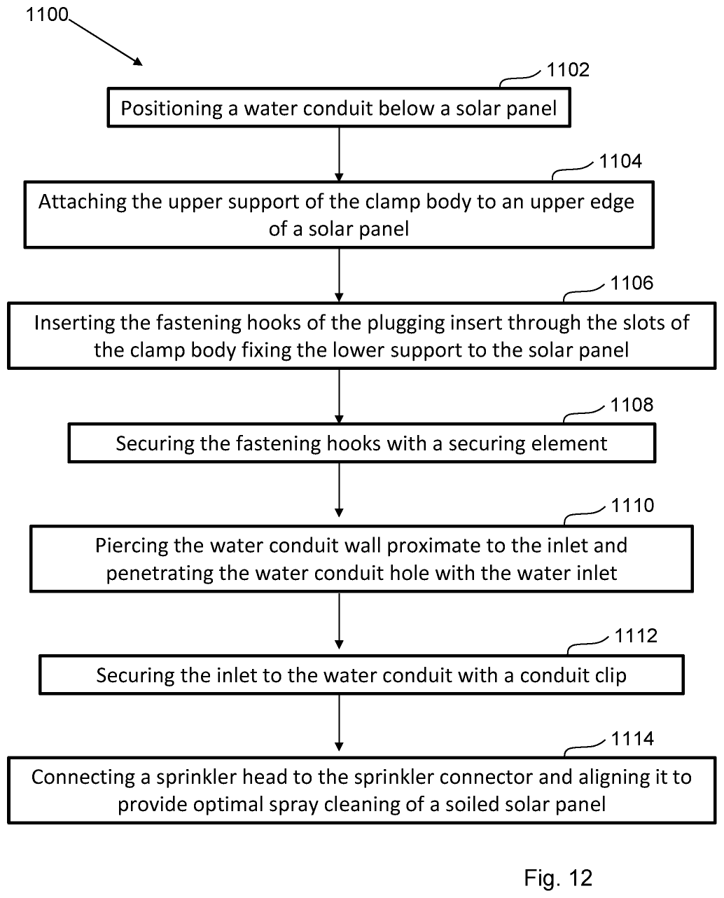

FIG. 12 is a flow diagram of the spraying interface in accordance with some embodiments of the invention;

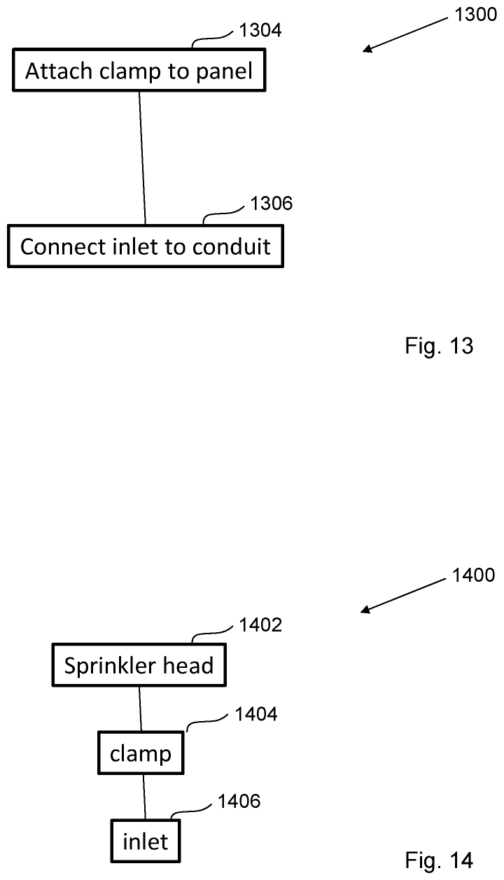

FIG. 13 is a flow diagram of the spraying interface in accordance with some embodiments of the invention; and

FIG. 14 is a block diagram of the spraying interface in accordance with some embodiments of the invention.

### DETAILED DESCRIPTION OF THE INVENTION

### Overview

The present invention, in some embodiments thereof, relates to a spraying interface for cleaning solar panels. In some embodiments, the spraying interface does not damage the body of the solar panel and produces little or no shadowed area on the solar panels. For example, the spraying interface may be attached to the body of a solar panel without drilling, welding, screwing, gluing or damaging the solar panel body. Additionally, the spraying interface may advantageously produce a reduced shadowed area on the solar panel, which may reduce loss of efficiency due to shadowing of the solar panel.

The present invention will now be described in terms of specific example embodiments. It is to be understood that the invention is not limited to the example embodiments disclosed. It should also be understood that not every feature of the methods and systems handling the described spraying interface is necessary to implement the invention as claimed in any particular one of the appended claims. Various elements and features of the invented article are described to fully enable the invention. It should also be understood that throughout this disclosure, where a method is shown or described, the steps of the method may be performed in any order or simultaneously, unless it is clear from the context that one step depends on another being performed first.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

According to some embodiments, a spraying interface may be clipped onto and/or over an edge of a solar panel. Optionally, the spray interface may be held securely against the side of the body of the solar panel. According to some embodiments, the spraying interface may be attached to the solar panel without drilling, welding, screwing, gluing and/or damaging the solar panel body.

According to some embodiments, affixing the spraying interface to the edge of the solar panel may produce a small to no shadowed area on the solar panel, thereby resulting in reduced or no reduction in efficiency in conversion of sunlight to solar energy due shadowing.

According to some embodiments, the spraying interface may connect to a system of water conduits running below and/or between the solar panels. Optionally, a spacer and/or extender may be used to link the spraying interface to one or more water conduits. Optionally, the spraying interface may be incorporated onto an existing system of water conduits. Optionally, the spraying interface may be attached to a solar panel quickly and/or easily without damaging the solar panel and voiding the manufacturers warrantee.

According to some embodiments, the spraying interface may be linked to a system which may be manually and/or automatically controlled. Optionally, the time and/or duration of spraying may be controlled manually and/or automatically. Optionally, the system may include one or more weather sensor e.g., to prevent operation of one or more spraying interfaces during unfavorable weather conditions, such as during high winds, rain, snow, etc. Optionally, the system may include one or more sensors to detect and/or operate and/or alert a user when cleaning of a solar panel may be required, e.g., by detecting a drop in efficiency. Optionally, the spraying interface may be operated daily, weekly, monthly, periodically and/or as needed to prevent loss of efficiency of the solar panel due to soiling.

According to some embodiments, the spraying interface may include an upper support and/or a lower support to attach the clamp body of the spraying interface to the edge of the solar panel. Optionally, the lower support may be reversibly attached to the clamp body of the spraying interface. Optionally, the lower support may be adjustable according to the size and/or width of the solar panel edge. Optionally, the lower support may be held in position on the spraying interface by one or more securing elements. Optionally, the lower support may be connected to a securing element by one or more fastening hooks, clips, locks, joins, etc. Optionally, the upper and lower supports may hold the clamp body of the spraying interface firmly against an edge of a solar panel.

According to some embodiments, the spraying interface may include a conduit inlet, which may be attached to and/or penetrate a water conduit. Optionally, a conduit inlet may be located at the base of the spraying interface. Optionally, the spraying interface may be connected securely to the water conduit by one or more conduit clips. Optionally, a conduit clip may be tightened by a securing ring attached to a collar of the conduit clip and/or the neck of the conduit inlet. Optionally, the conduit inlet may be connected to a fluid path which may carry water from the inlet to one or more sprinkler heads. Optionally, the conduit may be and/or may include a water conduit. Optionally, the spraying interface may include a spacer and/or extender between the conduit inlet and the clamp body of the spraying interface. Optionally, such a spacer and/or extender may allow connection of the spraying interface to one or more water conduit systems regardless of the distance between the solar panel and the water conduit system.

According to some embodiments, the spraying interface may include a sprinkler connector located at or near the upper region of the spraying interface. Optionally, the sprinkler connector may be attached to one or more sprinkler heads. Optionally, a sprinkler head may be adjustable. Optionally, a sprinkler head may be adjusted and/or positioned to provide maximum coverage and/or spray. Optionally, a sprinkler head may be adjusted and/or positioned to provide maximum cleaning of a soiled solar panel. Optionally, the spread of water from a sprinkler head may be determined by the slope of the inner surface and/or bore of the sprinkler head. Optionally, the slope and/or bore may be adjustable. Optionally, a variety of sprinkler heads with various slopes and/or bores may be attached to the sprinkler connector. Optionally, adjacent spraying interfaces may include sprinkler heads which may have the same or different slopes and/or bores. Optionally, a variety of sprinkler heads with various slopes and/or bores may be attached to a system of spraying interfaces to provide improved cleaning of one or more soiled solar panels, e.g., adjacent, in series, in parallel, opposite, etc. Optionally, the sprinkler head may rotate, at least in part, on ejection of water.

Some embodiments may relate to a method for installing and/or operating an automatic cleaning system for a solar panel using the spraying interface may include some or all of the following steps:
1. Positioning a water conduit (e.g., a flexible conduit) and/or system of water conduits below the solar panel/s.
2. Attaching the upper support of the spraying interface to an upper edge of a solar panel.
3. Inserting the fastening hooks of a plugging insert through slots of the clamp body to fix the lower support to the solar panel.
4. Securing the fastening hooks with a securing element so as to fill the space between the fastening hooks and the clamp body.
5. Piercing the water conduit wall proximate to the conduit inlet.
6. Placing a securing ring above the neck of conduit inlet.
7. Penetrating the conduit hole with the water inlet.
8. Placing the conduit clip collar over the neck of the conduit inlet such as to rest over the shoulder.
9. Lowering the securing ring over the collar to secure the conduit clip in place.
10. Connecting a sprinkler head to the sprinkler connector and aligning it to provide improved spray cleaning of a soiled solar panel.
11. Opening a faucet of the cleaning system to allow water to flow into the water conduit, feed the spraying interface and spray water over the solar panel.

### Specific Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention, in some embodiments thereof, relates to a spraying interface, and, more particularly, but not exclusively, for cleaning solar panels.

Reference is now made to the figures.

FIG. 1 is an exemplary image of a spraying interface fixed to an edge of a solar panel and connecting a water conduit with a sprinkler head, and FIG. 2 is an exemplary image of the spraying interface of FIG. 1, showing an upper support of the spraying interface holding the upper part of the solar panel edge in accordance with some embodiments. For example, the spraying interface 100 may be coupled to an edge 106 of a solar panel by mechanical structure external to the solar panel, such as not to damage the solar panel, and with little to no shadowing of the active part of the solar panel. The spraying interface may be attached to an edge 106 of a solar panel by an upper support 104 and a lower support 108. A water conduit 110 may be connected to the base of the spraying interface, and may be held in place by a water conduit 110 clip 114, which may be tightened in place by a securing ring 112. The incoming water may be channeled through the body 116 of the spraying interface to a sprinkler head 102 in the upper part thereof.

FIG. 3 is a perspective view of a spraying interface in accordance with some embodiments of the invention. For example, a spraying interface 200 may include a sprinkler head 202 located on the upper part of the spraying interface, which may be connected to a sprinkler connector (not shown) connected to an upper support 204 which may hook over the top of an edge of a solar panel and a reversibly attachable lower support 208, which may attach to the bottom of an edge of a solar panel. The lower support 208 may include an adjustable plugging insert 210 which may be attached to the clamp body 206 of the spraying interface by a securing element 214 by one or more fastening hooks 212. The spraying interface may include a conduit 110 inlet 218 at the base which may be attached to a water conduit 110 and/or held to the conduit by a conduit 110 clip 220. Optionally, the conduit inlet 218 is reversibly fastened to the spraying interface by a securing ring 216.

FIG. 4 is an exploded view of a schematic illustration of a spraying interface in accordance with some embodiments of the invention. For example, the spraying interface 300 may include a sprinkler head 302 for connection to a sprinkler connector 310. The sprinkler head 302 may be held in position and/or guided into position by one or more sidewalls 306 which may include one or more rails 304 on the upper surface of the upper support 308. The upper support 308 may be clipped and/or hung over the top of an edge of a solar panel. The clamp body 314 of the spraying interface 300 may include a fluid path 312 for water, and may be held securely against the edge of the solar panel by a lower support 334. The lower support 334 may be connected to the clamp body 314 through one or more slots 316 in the clamp body 314 and reversibly locked in place by a securing element 318 to which it may be connected by one or more fastening hooks 332. The lower support 334 may be adjustable, and or may include different configurations to conform to different shapes and/or sizes of solar panels, e.g., a plugging insert 336 between the lower support 334 and the one or more fastening hooks 332 may have various shapes and/or thicknesses and/or widths to accommodate various solar panels. The base of the spraying interface may include conduit 110 inlet 324 with a narrow neck 320 and a shoulder 322 over which a securing ring 326 may be placed to connect the conduit 110 inlet 324 to the collar 328 of a conduit 110 clip 330, which may be configured to attach to a water conduit 110.

FIG. 5 is a perspective view of a spraying interface in accordance with some embodiments of the invention. For example, the spraying interface 400 may include a sprinkler head 404 with a bore (not shown) and a slope 402 on the inner surface. Optionally, the spread of water from a sprinkler head 402 may be determined by the slope 402 of the inner surface and/or bore of the sprinkler head 404. Optionally, the slope and/or bore may be adjustable. Optionally, a variety of sprinkler heads with various slopes and/or bores may be attached to a sprinkler connector (not shown). Optionally, a variety of sprinkler heads with various slopes and/or bores may be attached to a system of spraying interfaces to provide improved cleaning of a soiled solar panels. Optionally, the sprinkler head may rotate, at least in part, on ejection of water.

According to some embodiments, the sprinkler connector (not shown) may be threaded and/or have a smooth outer surface to receive a sprinkler head with a bore which may have inner threading and/or be smooth, which may slide over the connector without any space for water leakage. Optionally, the connector may include two neighboring sidewalls with internal elongated rails.

According to some embodiments, the sprinkler head may have a square base for disposing between the sidewalls while overcoming friction with the elongated rails, which after placing the sprinkler head may secure the sprinkler head in place. Optionally, due to the square base, the sprinkler head may have four possible rotational states, spaced each 90° to each other.

According to some embodiments, a sprinkler bore may channel pressurized water towards a sloped inner plane of the sprinkler head, which may spread the water over an angle which may occupy a horizontal arc, e.g., between about 90-300°, 120-250°, or 180-230°, preferably 200-220°. Each possibility is a separate embodiment. Optionally, the direction of the spreading water may be fixed due to the fixed square base of the sprinkler.

The sprinkler head 401 may be held between one or more sidewalls 406 on the upper surface of the upper support 408 of the clamp body 410. The clamp body may include one or more slots 415 through which the fastening hooks 414 of a plugging insert 418 (spacer and/or support) of the lower support 416 may pass. The fastening hooks 414 may then be reversibly locked in place by a securing element 412, e.g., by a click system, joint system, etc. The base of the clamp body 410 may include a conduit 110 inlet 424 which may pierce and/or be inserted into a hole in a water conduit 110. The conduit 110 inlet 424 may be held in place in the water conduit 110 by a conduit 110 clip 422 which may be tightened by a securing ring 420 to prevent water leakage.

FIG. 6 is a rear view of a schematic illustration of a spraying interface in accordance with some embodiments of the invention. For example, the spraying interface 500 may include a sprinkler head 502 located on the upper portion of the clamp body 505 and connected fluidically to the conduit 110 inlet (not shown) by a fluid path 504 running the length of the clamp body 505. The lower support may be reversibly connected to the clamp body 505 by one or more fastening hooks 506 passing through one or more slots in the clamp body of the spraying interface and locked in place by a securing element 508. The securing element 508 may be U-shaped, e.g., so as not to prevent the flow of water to the sprinkler head 502 through the fluid path 504.

FIG. 7 is a side view of a schematic illustration of a spraying interface in accordance with some embodiments of the invention. For example, the spraying interface 600 may be attached to an edge of a solar panel without drilling, welding, screwing, gluing and/or damaging the solar panel body. The spraying interface 600 may be configured to attach to an edge of a solar panel by gripping the upper and lower surfaces of the edge of a solar panel using an upper support 602 and a lower support 604. The lower support 604 may be reversibly locked in place by a locking system including one or more fastening hooks 608 and a securing element 606 which may be connected without drilling, welding, screwing, gluing, etc., thereby preventing damage to the solar panel. Moreover, the spraying element may be securely attached to one or more water conduit 110s by a conduit 110 clip 616 reversibly locked in place by a locking system including a securing ring 610 to ensure that the conduit 110 inlet 612 entering the water conduit 110 does not move and/or does not leak.

FIG. 8 shows a perspective view of a schematic illustration of a spraying interface in accordance with some embodiments of the invention. For example, the spraying interface 700 may include a clamp body 706 which may have a water inlet 712 at the base and a sprinkler connector 702 at the upper end. An upper support 704 may protrude from the upper part of the clamp body 706 and may be configured to rest upon the upper surface of the edge of a solar panel, on a narrow non-active boundary or frame of the front side of the solar panel.

According to some embodiments, a plugging insert 718 may be plugged into corresponding slots (not shown) in the clamp body 706, while two fastening hooks 710 may slide over the internal sides of slots and may be poised over the slot ends to keep the plugging insert 718 in place. Optionally, a securing element 708 may be installed in a space therebetween and may prevent removal of the plugging insert 718 from the slots. Optionally, a plugging insert may have a lower support 720 for engagement with the lower side of an edge of a solar panel.

According to some embodiments, the inner surface of the clamp body 706 may touches the side of the edge of the solar panel, while the upper support may rest on and/or over the top edge of the solar panel and the lower support may be pressed against the lower edge of the solar panel. Optionally, the clamp body may be wide relative to its thickness. Optionally, the clamp body may be easily inserted within the space between adjacent panels.

According to some embodiments, a U-shaped conduit 110 clip 714 may be coupled to the clamp body and may be secured by a securing ring 716. Optionally, the conduit 110 clip 714 may be free to rotate relative to the clamp body and may allow connection to a water conduit 110 system with any angle of water conduit 110s relative to the solar panel/s. Optionally, a conduit 110 inlet may be configured to be coupled to a water conduit 110 and may receive incoming water, which may flow through the clamp body 706 to the sprinkler connector 702. Optionally, the connector may have a thread for receiving the sprinkler head, which in turn may be connected tightly to the connector despite the water pressure.

According to some embodiments, the water conduit 110 may be positioned substantially perpendicular to the long dimension of the clamp body. Optionally, the water conduit 110 may be connected directly to the spraying interface without a connecting conduit 110. Optionally, the water conduit 110 may be mechanically supported by a conduit 110 clip 714.

According to some embodiments, a fluid path may connect the water inlet 712 with the sprinkler connector 702 for feeding it with water from the water conduit 110.

FIG. 9A-C are perspective views of schematic illustrations of various exemplary plugging inserts in accordance with some embodiments of the invention. For example, the plugging insert may be shaped such as to have greater or lesser holding area on the bottom part of the plugging insert. Optionally, the plugging insert may be partially or completely hollow. Optionally, the plugging insert may be of various lengths and/or widths, and or thicknesses and/or shapes, e.g., to conform to various shapes and/or sizes of solar panels. Optionally, the plugging insert may be a one-piece injected polymer product. Optionally, the polymer may be non-toxic and/or shatter resistant, e.g., acrylic (polymethlamethacrylate), butyrate (cellulose acetate butyrate), polyvinyl chloride, polycarbonate, polyethylene terephthalate, glycol modified polyethylene terphthalate, polytetrafluoroethylene, polystyrene, polypropylene, polyamide, polyethylene, etc. Optionally, the plugging insert may include a lower support 802 on its upper proximal edge. Optionally, the plugging insert may include one or more fastening hooks 804 on its distal end.

According to some embodiments, the plugging insert may include one or more protruding plates while the clamp body include one or more corresponding slots for receiving the plates and/or tightening the plugging insert to the clamp body.

FIG. 10 is a block diagram of the clamp body of a spraying interface in accordance with some embodiments of the invention. For example, the clamp body 900 may include a sprinkler connector 902 on its upper portion, including one or more sidewalls 904 with one or more rails 906. The upper portion may include an upper support 908. The clamp body may include one or more slots 910. The clamp body may include a conduit 110 inlet 914 on its base which may be connected fluidically to the sprinkler connector 902 by a fluid path 912. Optionally, the clamp body may be a one-piece injected polymer product. Optionally, the fluid path 912 may be fully integrated therewithin.

FIG. 11 is a block diagram of the spraying interface in accordance with some embodiments of the invention. For example, the spraying interface 1000 may include a sprinkler head 1002 which may be attached to the clamp body 1004 of the spraying interface, which may be further connected to a plugging insert 1006, which may be locked in place by a securing element 1008. The clamp body 1004 may also be connected to a conduit 110 clip 1012, which may be fixed in place by a securing ring 1010.

FIG. 12 is a flow diagram of the spraying interface in accordance with some embodiments of the invention. For example, a method 1100 for attaching a spray interface including positioning 1102 a water conduit 110 and/or system of water conduits 110 below the solar panel/s. Attaching 1104 the upper support of the clamp body of the spraying interface to an upper edge of a solar panel. Inserting 1106 the fastening hooks of the plugging insert through the slots of the clamp body thereby fixing the lower support to the solar panel. Securing 1108 the fastening hooks with a securing element so as to fill the space between the fastening hooks and the clamp body. Piercing 1110 the water conduit 110 wall proximate to the conduit 110 inlet. Placing the securing ring above the neck of conduit 110 inlet. Penetrating the water conduit 110 hole with the water inlet. Placing 1112 the conduit 110 clip collar over the neck of the conduit 110 inlet such as to rest over the shoulder. Lowering the securing ring over the collar to secure the conduit 110 clip in place. Connecting 1114 a sprinkler head to the sprinkler connector and aligning it to provide improved spray cleaning of a soiled solar panel. Opening a faucet of the cleaning system to allow water to flow into the water conduit 110, feed the spraying interface and spray water over the solar panel. Optionally, a detergent may be added to the liquid sprayed onto the solar panel to improve cleaning.

FIG. 13 is a flow diagram of the spraying interface in accordance with some embodiments of the invention. For example, a method 1300 for attaching a spray interface includes attaching 1304 a clamp body of the spraying interface to an upper edge of a solar panel. For example, attachment may include clamping the clamp to the panel with an elastic element (e.g., elastic jaws and/or cushioned arms and/or elastic arms) and/or an adjustable element (e.g., a threaded tightener) and/or a removable element, for example, fastening hooks and/or a plugging insert. Optionally, the clamp includes a sprinkler head and/or a mount for the sprinkler head. Optionally, the clamp includes a water inlet and/or a mount for the water inlet. Optionally the water inlet and/or mount is connected to the sprinkler head and/or mount by a fluid path. For example, the fluid path may be intrinsic to the clamp (e.g., a channel therethrough) and/or extrinsic to the clamp (e.g., a tube).

In some embodiments, the water inlet is connected 1306 to a water conduit. For example, connecting may include piercing a wall of the water conduit and/or inserting the insert through the pierced opening. Alternatively or additionally, the inlet may be connected to the conduit with any sort of plumbing connector. The conduit may include a flexible tube and/or a rigid tube. The conduit may be made of plastic, metal and/or another material. Optionally, a clip holds the conduit to the clamp and/or panel.

FIG. 14 is a block diagram of the spraying interface in accordance with some embodiments of the invention. For example, the spraying interface 1000 may include a sprinkler head 1402 which may be attached to a clamp 1404 of the spraying interface, which may be further connected to an inlet 1406, The clamp 1404 may also be connected a solar panel and the inlet connected to a conduit 110. The clamp may include various mechanisms to clamp to the panel, for example, jaws with an elastic element and/or a fastening hooks and/or fastening hooks holding a lower plugging insert to a clamp body and/or the panel. Alternatively or additionally, there may be threaded element and/or a threaded tightener. Optionally, the inlet 1406 includes a barbed tube, for example the barbed tube may be inserted into and/or hold fast to the walls of a flexible hose (e.g., a plastic irrigation hose). Optionally the sprinkler head may be reversibly attached to the clamp and/or may be replaceable and/or adjustable and/or fixed.

According to some embodiments, the spray interface may be partially or completely recyclable. Optionally, the spray interface may be constructed completely or partially from recycled materials.

### General

It is expected that during the life of a patent maturing from this application many relevant building technologies, artificial intelligence methodologies, computer user interfaces, image capture devices will be developed and the scope of the terms for design elements, analysis routines, user devices is intended to include all such new technologies a priori.

Some of the methods described herein are generally designed only for use by a computer, and/or may not be feasible or practical for performing purely manually, by a human expert. A human expert who wanted to manually perform similar tasks might be expected to use completely different methods, e.g., making use of expert knowledge and/or the pattern recognition capabilities of the human brain, which would be vastly more efficient than manually going through the steps of the methods described herein.

As used herein the term “about” refers to ±10%

The terms “comprises”, “comprising”, “includes”, “including”, “having” and their conjugates mean “including but not limited to”.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

To the extent that section headings are used, they should not be construed as necessarily limiting.

What is claimed is:

1. A device for cleaning solar panels comprising:
a sprinkler head;
an inlet attachable to a water conduit;
a fluid path leading from the water inlet to the sprinkler head
a clamp configured to clamp to a solar panel and support said sprinkler head, said inlet and said fluid path.

2. The device of claim 1, wherein the clamp includes a clamp body including:
a sprinkler connector on an upper portion of the clamp body;
an upper support on an upper portion of the clamp body;
at least one slot; and
a conduit inlet on a base of the clamp body configured to be fluidically connected to the sprinkler connector by a fluid path;
a plugging insert comprising a lower support and at least one fastening hook configured to be inserted through the at least one slot in the clamp body and reversibly locked in place by a securing element.

3. The device according to claim 1, wherein the fluid path is fully integrated within the clamp body.

4. The device according to claim 1, wherein the clamp body is a one-piece injected polymer product.

5. The device according to claim 1, further comprising a conduit clip configured to be attached to a water conduit and to be fixed in place by a securing ring.

6. The device according to claim 1, wherein the sprinkler head comprises a sloped inner plane configured to spread water over an angle occupying a horizontal arc between about 90-300°, 120-250°, 180-230°, or 200-220°.

7. The device according to claim 1, wherein the sprinkler head comprises a square base.

8. The device according to claim 2, wherein the sprinkler connector comprises one or more sidewalls with one or more rails.

9. The device according to claim 2, wherein the plugging insert is partially or completely hollow.

10. The device according to claim 2, wherein the plugging insert is configured conform to various shapes and/or sizes of solar panels.

11. The device according to claim 2, wherein the plugging insert comprises a lower support on an upper proximal edge.

12. The device according to claim 2, wherein the plugging insert comprises at least one fastening hook on its distal end.

13. The device according to claim 2, wherein the conduit inlet comprises a narrow neck and a shoulder.

14. The device according to claim 2, wherein the conduit inlet is configured to penetrate a water conduit.

15. The device according to claim 2, wherein a securing ring is configured to connect the conduit inlet to a conduit clip.

16. The device according to claim 2, wherein the device is configured to be connected to a solar panel without drilling, welding, screwing, gluing or damaging the solar panel.

17. A method for installing a spray interface for cleaning solar panels, the method comprising:
attaching a clamp to an upper edge of a solar panel;
connecting an inlet to a water supply conduit.

18. A method for installing a spray interface for cleaning solar panels, the method comprising:
positioning a water conduit below a solar panel;
attaching an upper support of a clamp body of the spray interface to an upper edge of a solar panel;
inserting at least one fastening hook of a plugging insert through at least one slot in the clamp body, thereby fixing the lower support to the solar panel;
securing the at least one fastening hook with a securing element;
piercing the water conduit proximate to a conduit inlet on a base of the clamp body;
penetrating the water conduit with a water inlet;
securing the water inlet to the water conduit using a conduit clip secured by a securing ring;
connecting a sprinkler head to a sprinkler connector on an upper portion of the clamp body; and
aligning the sprinkler head to provide improved spray cleaning of a soiled solar panel.

19. The method according to claim 18, further comprising placing a conduit clip collar over a neck of the conduit inlet to rest over a shoulder of the conduit inlet, and lowering the securing ring over the collar to secure the conduit clip in place.

20. The method according to claim 18, further comprising linking the spraying interface to a system which is manually and/or automatically controlled.

21. The method according to claim 20, further comprising at least one weather sensor configured to prevent operation of the spraying interface during unfavorable weather conditions.

22. The method according to claim 20, further comprising at least one sensor to detect when cleaning of a solar panel is required to prevent loss of efficiency of the solar panel due to soiling.

23. The method according to claim 18, wherein the installing is without drilling, welding, screwing, gluing or damaging the solar panel.

24. The method according to claim 18, wherein the installing results in low to no shadowing of the solar panel.
